(19) United States
(12) Patent Application Publication
(10) Pub. No.: US 2004/0244566 A1
(43) Pub. Date: Dec. 9, 2004

(54) Method and apparatus for producing acoustical guitar sounds using an electric guitar

(76) Inventor: H. M. Steiger, Phoenix, AZ (US)

Correspondence Address: TOD R. NISSLE, P.C., P.O. Box 55630, Phoenix, AZ, 85078, US

(21) Appl. No.: 10/428,201

(22) Filed: Apr. 30, 2003

(51) Int. Cl. G10H 1/36; G10H 7/00

(52) U.S. Cl. 84/610

(57) ABSTRACT

An electric guitar facilitates isolating principles of making music such that an individual can learn one aspect at a time of playing the guitar and of playing music and can, to match the skill level of the player, progressively require more aspects to be mastered in order to play the guitar. The guitar includes one mode which requires only that the player strum the strings, includes a second mode which requires the player to play the strings and depress buttons, and includes a third mode that requires the player to play the strings and depress specific buttons on the guitar.

This invention pertains to guitars.

More particularly, this invention pertains to a method and apparatus for producing acoustical guitar sounds by using an electric guitar.

The first references to stringed instruments appears in Persian and Chinese writing from the 800's. Developments over the next 800 years lead to a variety of stringed instruments including the violin. The violin includes a hollow body or “box”, a fingerboard or neck attached to the body, and a plurality of strings extending over the body and fingerboard. A bow is utilized to produce vibrations in the strings. The body resonates and amplifies sound produced by the vibrating strings. The body of a violin is constructed utilizing wood, glue, and varnish or oil. The methods used to construct a violin determine the tone and amplification achieved when the violin is played. The violins made in the 1600's by Antonio Stradivarius are some of the finest made, and other violin makers have for many years attempted to discover and duplicate the techniques utilized by Stradivarius. Because of the craftsmanship involved in making a violin, and because of variations in the wood and other materials utilized to make the violin, each individual violin often has its own “fingerprint” in terms of the sounds it produces. Musicians can often, for example, distinguish the sound made by one Stradivarius violin from the sound produced by another Stradivarius violin. The sound made by each string, in concert with the various harmonics produced by the strings and the resonant reaction of the violin body to such sounds, collectively contribute to the sound produced by a violin.

The acoustic guitar is another popular stringed instrument. Like a violin, a guitar has a hollow body, a fingerboard, and strings which extend across the body and fingerboard. Like a violin, the body of the guitar functions to resonate when the strings are played and to amplify sound produced by the vibrating strings. The vibration of a guitar string resonates in the top and bottom plates of the guitar, as well as in the air inside the guitar. Characteristics of the guitar body determine the tone produced by the guitar. For example, the materials used to construct the body, the thickness of the materials, how the face plate and back plate of the body are shaped and are connected to the bouts, etc. contribute to the tone produced when the guitar body resonates and amplifies sound produced by the strings.

An electric guitar includes a body, a fingerboard, strings, and transducers mounted on the body adjacent the strings. The electric guitar is connected to an amplifier and a speaker by an electric cord. Controls on the guitar regulate the sound produced by the guitar. Controls on the external amplifier also further regulate and modify the sound produced by the guitar. When an electric guitar is played, the vibration of each string is sensed by the transducer. Signals generated by the transducer are electronically processed and produce amplified sound that emanates from a speaker that is connected to the electric guitar. An advantage of the electric guitar is the ability to greatly amplify sound. Another advantage is the ability to electronically manipulate the sound. A disadvantage of an electric guitar With respect to an acoustic guitar is that the electric guitar does not utilize a resonating hollow body to produce and amplify sound. The hollow body and tonal qualities of the acoustic guitar are sacrificed for the ability to electronically amplify and electronically manipulate sound. These tonal qualities are often important to the musician and to the listener, which is one reason symphony orchestras do not use electric violins.

Other electronic instruments exist which synthetically produce the notes produced when a guitar is played. For example, electronic keyboards exist which, when a key on the keyboard is depressed, will produce the sound of a guitar, trumpet, or other instrument. One way electronic synthetic instruments produce notes is by using a mathematical analog algorithm to produce the note. Another way electronic synthetic instruments produce notes is by using the first two to three seconds of a digital file. The digital file comprises a digital recording made when the note is played on a selected instrument—for example, a guitar. The first two to three seconds of the digital file includes the “attack” portion of the note and a part of the “decay” portion of the note. The last part of the decay portion is repeated over and over to simulate artificially the remainder of the decay portion of the note. Accordingly, instruments which synthetically produce the sound of a guitar rely on electronic digital processing and do not require the resonating body, the strings, or any other part of a guitar. Synthetic instruments eliminate the need for and the tonal qualities associated with an acoustic guitar, as well as eliminating the need for musicians to learn to play a guitar. Synthetic instruments similarly eliminate the need for an electric guitar because vibrating strings are not utilized by synthetic instruments to produce sound in synthetic instruments.

While electric guitars are in wide use and are championed by many individuals, one disadvantage of an electric guitar is that the sound it produces is not as rich and does not have the tonal qualities of notes produced by an acoustic guitar. Another disadvantage of a conventional electric guitar is that it does not satisfactorily simulate the playing characteristics of an acoustic guitar because when a user puts his hand across all of the strings of an electric guitar to mute the guitar, a spike of sound is produced followed by no sound because vibration of the strings is stopped. In contrast, when a user places his hand across all of the strings of an acoustic guitar to mute the guitar, vibration of the strings is halted and the acoustic guitar immediately stops producing sound.

Accordingly, it would be highly desirable to produce an electric guitar which more nearly replicated the playing qualities of an acoustic guitar and which produced tonal qualities comparable to that of an acoustic guitar.

It would also be highly desirable to produce an electric guitar which an individual could learn to play during a time span that was less than the time span ordinarily required to learn to play an acoustic guitar or an electric guitar.

Therefore, it is a principal object of the instant invention to provide an improved electric guitar.

Another object of the invention is to provide a method of producing an electric guitar which electronically senses movement of the guitar strings and produces the resonant acoustic sounds of an acoustic guitar.

A further object of the invention is to provide an improved electric guitar in which the sound produced by vibration of the strings is muted so it generally is not audible to a person listening to the guitar.

Still another object of the invention is to provide an improved electric guitar in which the sounds produced during muting of the strings comprise sounds produced by a resonating hollow body.

Yet a further object of the invention is to provide an improved electric guitar which an individual with limited or no musical experience can quickly learn to play.

Yet still a further object of the invention is to provide an improved electric guitar that facilitates isolating principles of making music so that an individual can learn one aspect at a time of playing the guitar and of playing music and can, to match the skill level of the player, progressively require more aspects to be mastered in order to play the guitar and to play music.

These and other, further and more specific objects and advantages of the invention will be apparent to those skilled in the art from the following detailed description thereof, taken in conjunction with the drawings, in which:

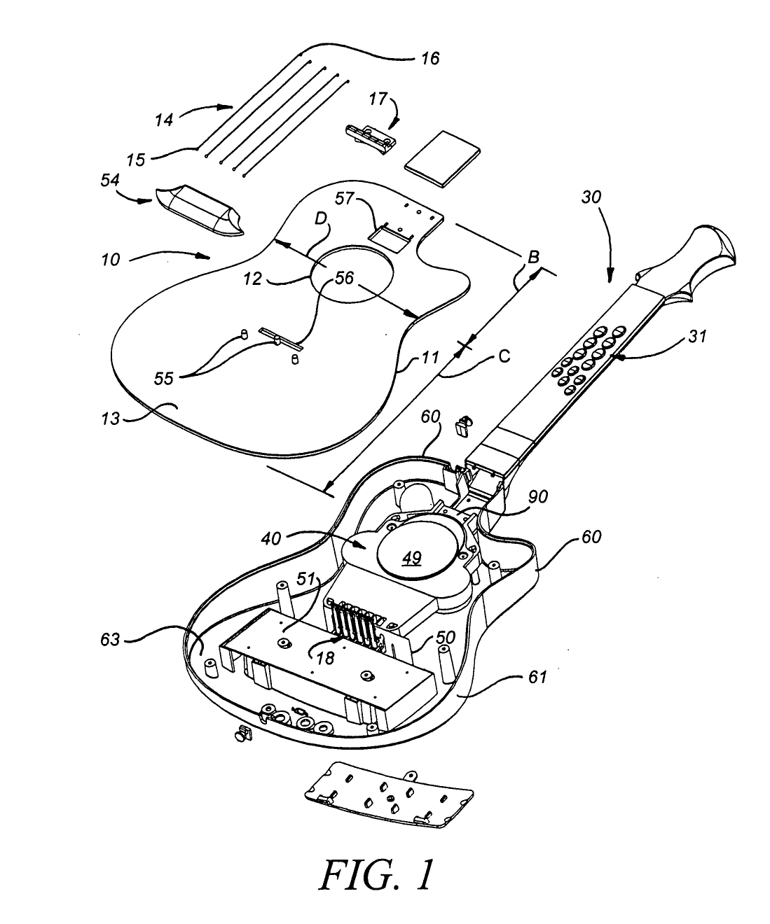

FIG. 1 is an exploded view of a guitar constructed in accordance with the principles of the invention;

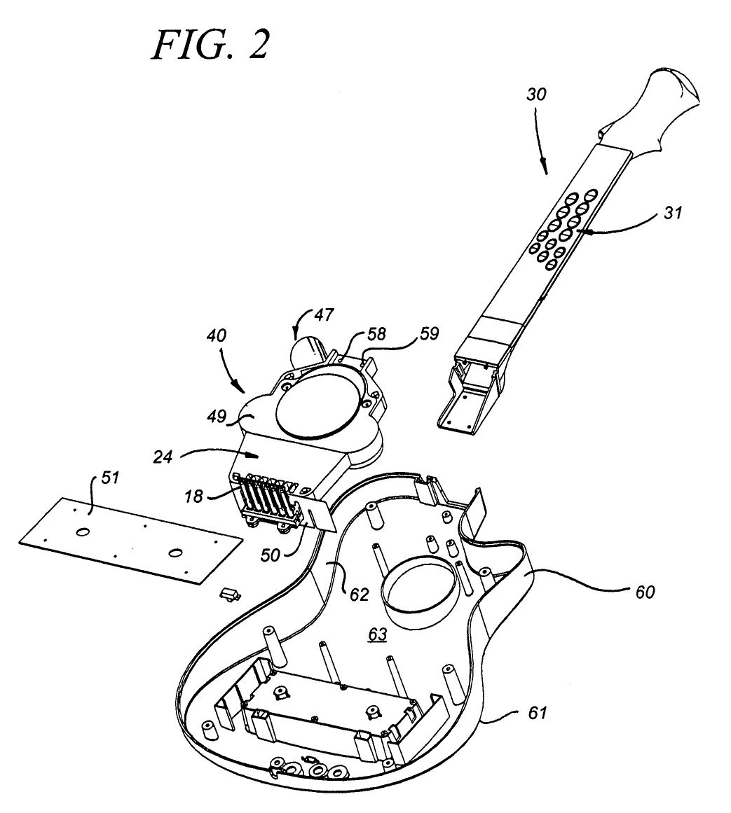

FIG. 2 is an exploded view of the strummer assembly, neck assembly, and back plate—bout assembly of the guitar of FIG. 1 illustrating further construction details thereof;

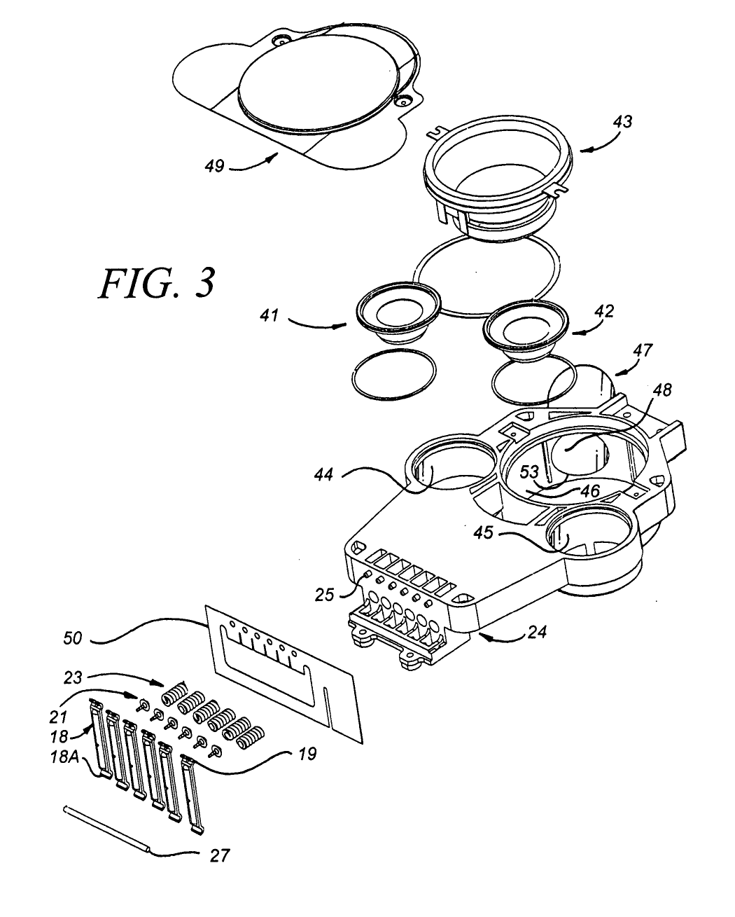

FIG. 3 is an exploded view of the strummer assembly illustrating additional construction details thereof;

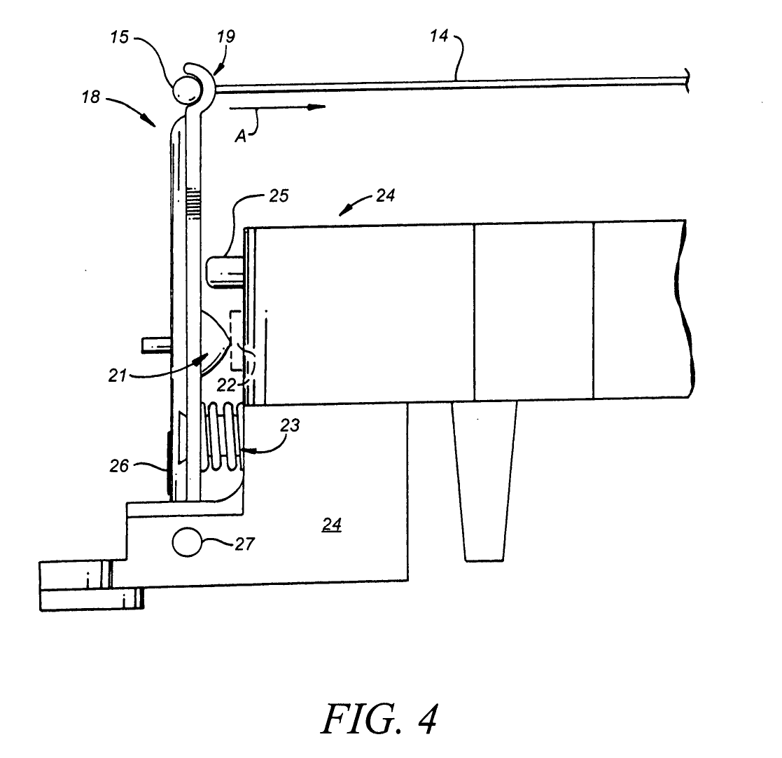

FIG. 4 is a side view of a portion of the strummer assembly illustrating in greater detail the lever arms displaced during strumming of the strings of the electric guitar of the invention;

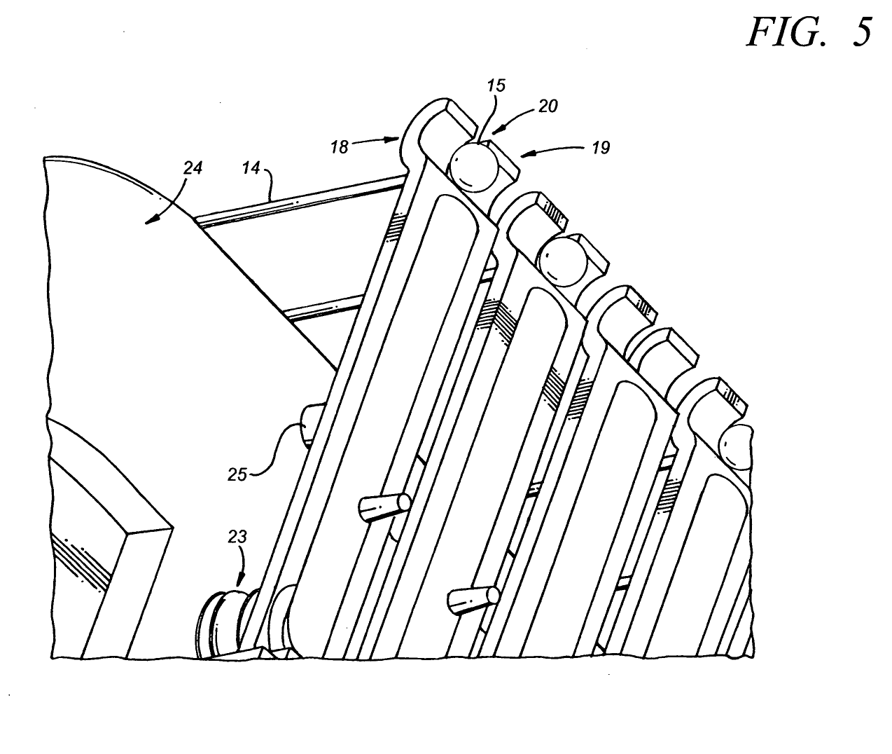

FIG. 5 is a front perspective view further illustrating the lever arms in the strummer assembly; and,

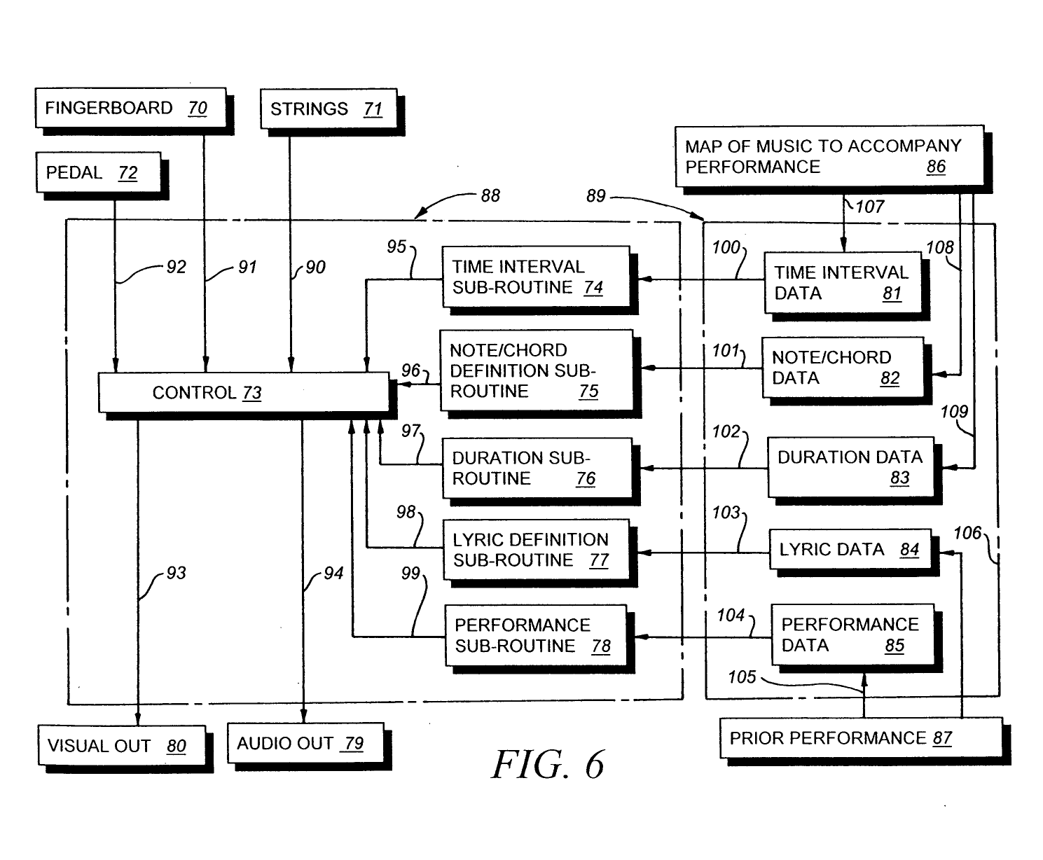

FIG. 6 is a block flow diagram illustrating the karaoke embodiment of the invention which permits a player to accompany the performance of a prior recording of a musical piece.

Briefly, in accordance with my invention, I provide an improved electric guitar. The guitar includes a hollow acoustic body to amplify sound; a plurality of strings mounted on the hollow acoustic body; a fingerboard attached to the hollow acoustic body; air in the hollow acoustic body; at least one sound speaker mounted in the hollow acoustic body; apparatus operatively associated with the strings and the speaker to cause, when the strings are played, sound to emanate from the speaker and to vibrate and resonate the hollow acoustic body and air in the hollow acoustic body and emanate outwardly from the hollow acoustic body.

In another embodiment of my invention, I provide an improved method for producing sound. The sound comprises a plurality of notes of a guitar in the range of 80 Hz to 1318 Hz. The method comprises the steps of providing an acoustic frame including a hollow acoustic body to amplify sound, air in the hollow acoustic body, and a fingerboard attached to the acoustic body; mounting strings on the hollow acoustic body; mounting a speaker inside the hollow acoustic body; mounting on the hollow acoustic body sound production means operatively associated with the strings and the speaker to cause, when the strings are played, sound simultaneously to emanate from the speaker and to vibrate and resonate the hollow acoustic body and the air in the hollow acoustic body and emanate outwardly from the hollow acoustic body; and, playing the strings to cause the sound production means to cause sound simultaneously to emanate from the speaker and to vibrate and resonate the hollow acoustic body and the air in the hollow acoustic body.

In a further embodiment of the invention, I provide an improved system for accompanying a recording of a prior musical performance including lyrics and music. The system includes a memory to store the recording of the prior musical performance, including the lyrics and the music; and, an accompaniment of the prior musical performance. The accompaniment includes chord data, duration data, and time interval data. The system also includes apparatus operatively associated with the memory for playing the recording; synchronizing the accompaniment with the playing of the recording; synchronizing the chord data with the lyrics; producing during the playing of the recording a visual display of the synchronized chord data and lyrics; and, playing the accompaniment during the playing of the recording.

In still another embodiment of the invention, I provide an improved system for accompanying a recording of a prior musical performance including lyrics and music. The system includes a memory to store the recording of the prior musical performance, including the lyrics and the music; and, an accompaniment of the prior musical performance. The accompaniment includes chord data, duration data, and time interval data. The system also includes apparatus operatively associated with the memory for playing the recording; and, an electric guitar including input members actuated by a player at time intervals to produce chords defined by the chord data and the duration data in a sequence defined by the accompaniment.

In still a further embodiment of the invention, I provide a system for accompanying a recording of a prior musical performance including lyrics and music. The system includes a memory to store the recording of the prior musical performance, including the lyrics and the music; and, an accompaniment of the prior musical performance. The accompaniment includes chord data, duration data, and time interval data. The system also includes apparatus operatively associated with the memory apparatus for playing the recording; and, an electric guitar system including first input members actuated by a player at time intervals to select chords defined by the chord data in a sequence defined by the accompaniment, and second input members actuated by a player at time intervals defined by the time interval data to play the chords selected by the first input members to replicate the chord data in the accompaniment.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates a guitar including a face plate 10, neck assembly 30, back plate 63—bout 60, 61 assembly, and strummer assembly 40 mounted in the back plate 63—bout 60, 61 assembly. Neck assembly 30 includes fingerboard 31.

Face plate 10 includes sound hole 12 formed therethrough, slot 56 formed therethrough to receive levers 18 of strummer assembly 40, and rectangular opening 57 formed therethrough. Foot 54 is affixed to plate 10 by pegs 55. String holder 17 extends from surface 90 of strummer assembly 40 outwardly through opening 57. The first end 15 of each string 14 is received by slot 20 formed in the upper end 19 of a lever 18 (FIG. 5). The other end 16 of each string 14 is received by the string holder 17.

The upper third of plate 10 is indicated by arrows B. The lower two thirds of plate 10 is indicated by arrows C. The sound hole 12 extends through plate 10 and ordinarily is positioned in the upper third of plate 10.

The strummer assembly 40 includes cover 49 mounted on housing 24. Cover 49 extends over speakers 41, 42, 43 mounted in cylindrical openings having cylindrical walls 44, 45, 46, respectively (FIG. 3). Generally circular opening 53 is formed in wall 46. Elongate hollow generally cylindrical port 47 is connected to wall 46 such that a portion of the sound from speaker 43 can exit through opening 53 and travel along the interior of port 47 outwardly from opening 53 toward bout 60. Port 47 includes cylindrical inner wall 48. Port 47 is functionally tunable by altering the shape of the port to contour the sound pressure to a desirable range of sound.

The lower or proximal end or “finger” 18A of each lever 18 pivotally partially circumscribes and engages pin 27. A conically shaped foot 21 is mounted in the intermediate portion of each lever 18. Each lever 18 is operatively associated with a spring 23 that interconnects housing 24 and lever 18. After lever 18 is displaced in the direction of arrow A (FIG. 4) when the string 14 associated with lever 18 is played (i.e., when string 14 is displaced or pulled by the finger or fingers of the user), spring 23 forces lever 18 back to the normal operative position illustrated in FIG. 4. Each lever 18 is also operatively associated with a stop 25 which prevents the upper or distal end of the lever 18 from contacting housing 24 and thereby crushing or otherwise damaging sensor 22 with plunger 21 when lever 18 is displaced in the direction of arrow A. Each foot 21 is operatively associated with a sensor 22. When lever 18 is displaced in the direction of arrow A, foot 21 compresses a sensor 22. Sensor 22, when so compressed, sends a signal to a microprocessor mounted in the guitar. The microprocessor causes sound to emanate from speakers 41, 42, 43. Sensor 22 and the microprocessor are sensitive to the amount of compressive force applied by foot 21. Consequently, the harder foot 21 presses against sensor 22 (i.e., the more force applied to sensor 22 by foot 21), the greater the volume or loudness of sound produced by speakers 41, 42, 43. The greater the distance a string 14 is pulled or displaced by the finger(s) of a user, the greater the forces applied against sensor 22 by foot 21.

When depressed, each button 31 in neck assembly 30 transmits a signal to the microprocessor mounted in the guitar of FIG. 1. The signals produced by each button cause the microprocessor to assign a particular sound to one or more strings 14 when that string is played (i.e., pulled or displaced by a user). When a string is played, the foot 21 associated with the string is displaced in the direction of arrow A, the foot 21 contacts and produces a compressive force on sensor 22, sensor 22 sends a signal which is detected by the microprocessor, the microprocessor causes sound to emanate from the speakers 41 to 43, and the sound emanating from the speakers 41 to 43 resonates in the hollow body of the guitar and is amplified. For example, if a selected one of buttons 31 is depressed, the microprocessor can cause speakers 41 to 43 to produce the sound for an “A” note (or “E” note or “D” note or “C” note, etc.) when a particular string 14 is strummed and the sensor 22 associated with that string produces a signal to the microprocessor.

When the force with which a user displaces or pulls a string 14 increases, the sensor 22 associated with the string 14 produces a signal which indicates that the string 14 is pulled “harder”. The microprocessor receives this signal and directs speakers 41 to 43 to produce sound having a greater amplitude. When the force with which a user displaces or pulls a string 14 decreases, the sensor associated with the string 14 produces a signal which indicates that the string 14 is pulled less. The microprocessor receives this signal and directs speakers 41 to 43 to produce a softer sound.

The microprocessor can, if desired, cause speakers 41 to 43 to produce notes having a frequency in the range of twenty to twenty thousand Hz. The microprocessor preferably produces notes in the range of forty Hz to about thirteen hundred, eighteen Hz. When it is desired that the electric guitar of the invention function as a bass guitar, microprocessor can enable speakers 41 to 43 to produce only notes each having a frequency in the range of forty hertz to three hundred, twenty hertz.

The hollow acoustic body of the guitar of the invention—including the face plate 10 and back plate 63 and bout 60 and 61—is critical in the practice of the invention because it functions to resonate and amplify sound. Such a resonating body apparently has not been utilized in an electric guitar and is important in producing a sound which has acoustic tonal qualities and which simulates an acoustic guitar. The peripheral edge 11 of front plate 10 (as well as the peripheral edge of back plate 63) must have a non-linear curvature. An edge has non-linear curvature when different points along the arcuate edge are produced by different radii vectors. In other words, sections or points on edge 11 lie on circles having different radii. A circle has a linear curvature because all points on the circle are produced by a radius (or “radii vector”) having the same length. In contrast, different points on edge 11 lie on circles having radii with different lengths. Edge 11 preferably includes points lying on a great many different sized circles each having a radii with a different length. The many different radii enable plate 10 to vibrate naturally at many different resonance frequencies and to assist in the amplification of any frequency note played on the guitar. In order to resonate, plates 10 and 63 and bouts 60 and 61 must be relatively thin, and have a thickness in the range of 0.050 to 0.250 inch. It is also preferred that the distances or widths between opposite sides or edges of plate 10—for example the distance or width indicated by arrows D—vary to facilitate the plates being able to resonate at different sound frequencies. The curvature of the plates assures that these distances or widths vary along the plate 10.

If the resonating hollow body of the guitar (comprising plates 10 and 63 and bouts 60, 61, but not including the strummer assembly 40 and other electronic components mounted in or on the hollow body in FIGS. 1 and 2) is utilized in a conventional acoustic guitar (with a fingerboard and strings attached to the hollow body in conventional fashion), then when one or more strings are played and vibrate and produce sound having a loudness in the range of thirty decibels to forty decibels, the hollow body resonates and amplifies the sound produced by the strings from two to sixty-four times. If the sound produced by the vibrating string(s) has a loudness of thirty decibels, the hollow body typically amplifies the sound from the strings such that the sound emanating from the hollow body has a loudness in the range of forty to fifty decibels (i.e., amplifies the sound from two to four times). If the sound produced by the vibrating string(s) has a loudness of forty decibels, the hollow body typically amplifies the sound from the strings such that the sound emanating from the hollow body has a loudness in the range of fifty to ninety decibels (i.e., amplifies the sound from two to thirty-two times). Consequently, it is preferred that the hollow body amplifies a thirty decibel sound produced by a vibrating string from two to sixteen times; and, amplifies a forty decibel sound produced by a vibrating string from two to sixty-four times. When the hollow body is utilized in the guitar of the invention, the hollow body functions to amplify sound emanating from speakers 41 to 43 and having a frequency in the range of 20 Hz to 20,000 Hz, 40 Hz to 1318 Hz, 40 Hz to 320 Hz, and/or any other desired frequency range. The hollow body can be fabricated from any desired material, but preferably is made from wood or plastic or various composites. Speakers 41 to 43 receive sound from an amplifier (not visible) mounted in the strummer assembly 40. Speakers 41 to 43 typically produce sound having a loudness in the range of thirty to ninety decibels, although the loudness of sound produced by speakers 41 to 43 can vary as desired.

Port 47 plays an important role in the sound resonating—amplification function of the guitar of the invention. Port 47 facilitates the resonation—amplification function of the guitar of the invention by directing sound to bout 60 so that the sound either can travel along bouts 60 and 61 by traveling through the bouts in the same manner that sound travels through water or can travel along and over the surface of bouts 60 and 61. If desired, more than one port 47 can be utilized to direct sound from one or more speakers 41 to 43 outwardly to bouts 60 and/or 61. Port 47 can also direct sound from one or more speakers 41 to 43 to face plate 10 or back plate 63 or bouts 60 and 61.

It is presently preferred that a guitar constructed in accordance with the invention include a plurality of strings 14. If desired, however, the strings 14 can be replaced by or used in conjunction with other components which can be manipulated by a user's fingers. Such components can be levers, buttons, a touch sensitive pad in which certain areas of the pad produce certain notes, etc.

The relative noise loudness produced by the guitar of the invention to the person playing the guitar is preferably in the range of five to ninety decibels. The sound pressure produced at the ears of the person playing the guitar is preferably in the range of about 0.002 dynes per square centimeter to twenty dynes per square centimeter. The power produced at the ear of the person playing the guitar is preferably in the range of 10⁻¹³ watts per square centimeter to 10⁻⁶ watts per square centimeter.

The shortest distance D (FIG. 1) across the face plate 10 of a full size guitar is about seven and one-half inches. The circular sound hole 12 presently has a diameter of about three and three-quarters inches. The ratio of the diameter of sound hole 12 to the shortest distance D across the face plate is preferably in the range of 1.5:1 to 3.5:1. This ratio is important in determining the tonal quality, resonance, and amplification of sound emanating from the guitar.

If desired, the location, diameter, and shape of sound hole 12 in plate 10 can vary as desired. More than one sound hole can be utilized. One or more sound holes may be formed in bouts 60, 61 and back plate 63. As noted, however, sound hole 12 is preferably located in the upper third of face plate 10.

One or more speakers 41 to 43 are preferably (but not necessarily) positioned beneath plate 10 such that sound emanating from the speaker(s) travels outwardly through sound hole 12. In FIG. 1, speaker 43 is positioned beneath and is generally centered on sound hole 12 such that sound emanating outwardly from speaker 43 travels out through sound hole 12. Positioning a speaker 41 to 43 in registration with sound hole 12 is preferred because the sound emanating from the speaker is not altered by passing through face plate 10, but instead emanates outwardly from the guitar and mixes with sound produced by the natural vibrations of faceplate 10, back plate 63, and bouts 60 and 61. Consequently, the combination of a speaker in a hollow resonating body is important in the invention.

Strings 14 vibrate when played, but are insulated and muted so that only a minimal amount, if any, sound is produced by the string vibration per se. Any desired means may be used to mute the sound produced by the vibration of a string 14. Presently the entire strummer assembly 40 is insulated with grommets from the face plate 10, back plate 63, and bouts 60 and 61. Openings or materials can be incorporated in strummer assembly 40 to dampen the vibration of assembly 40.

The microprocessor utilized in the invention is used in conjunction with a memory which contains from seven to two thousand chords. The microprocessor is utilized in conjunction with a memory which stores for each note or chord a digital file representing the “wave file” of each note or chord. Conventional synthesizers typically utilize mathematical algorithms to create synthetically a tone or note. Other higher quality synthesizers utilize digital sampling to create the basis of the sound generated. The digital samples are modified with synthesized algorithms to create harmonics and longer lasting sounds. As earlier noted, digital sampling takes only a portion of the digital recording of a note, typically the initial “attack/decay” portion of the recording. Synthesized algorithms are used to take part of the “decay” portion and repeat it over and over and make the note “decay” artificially. The guitar of the invention also utilizes at least a portion of the complete digital recording of a note or chord, start to finish. The complete digital recording of a note lasts about eight to ten seconds. The guitar of the invention, however, preferably (but not necessarily) does not apply an artificial or mathematical algorithm to the digital sampling portion utilized. Instead, the sound of the note as recorded is utilized. The note is recorded by strumming an actual guitar string (or strings) and recording the sound produced. As a result, the electric guitar of the invention provides high quality realistic sound. The initial “attack/decay” portion used in digital samples lasts only about one-half to two seconds. The portion of the digital recording used in the invention is preferably (but not necessarily) at least the first three to four seconds.

During use of the guitar of the invention, the microprocessor selects from memory the appropriate digital file of the note being “played” when a user strums a particular string. The file selected is utilized to generate a signal which causes sound to emanate from speakers 41 to 43. The electronics necessary to take the digital file of a note and generate sound at speakers 41 to 43 is well known in the art and is not detailed herein.

Sensor 22 can comprise any desired sensor including, by way of example and not limitation, optical sensors, stress sensors, strain sensors, electronic sensors, etc. Sensor 22 need not be activated by pad 21, but can detect movement of a string 14 by any other desired means. For example, a transducer detects movement of a string in an electromagnetic field adjacent the transducer.

It is presently preferred that the sensor 22 comprise rubber or some other compressible elastic electrically-insulative material impregnated with a plurality of electrically conductive fibers. The fibers are preferably in parallel, spaced apart relationship. Even when sensor 22 is not compressed by a pad 21, some of the carbon fibers in sensor 22 contact each other so that electricity continuously flows through sensor 20 and is detected by the microprocessor. When the sensor 22 is compressed, more of the fibers contact each other, permitting a greater quantity of electricity to flow through the sensor from one side of the sensor to the other side of the sensor. The more the sensor is compressed, the greater the number of fibers that contact each other and the greater the amount of electricity that flows through the sensor per unit of time. Consequently, when a user uses more force to “play” or displace a string, pad 21 produces an increased compressive force on sensor 22, and a greater amount of electricity flows through sensor 22. The microprocessor detects the amount of electricity flowing through sensor 22, and accordingly adjusts the volume of sound produced by speakers 41 to 43.

When a conventional acoustic guitar is utilized, the vibration of the strings of the guitar is stopped by placing a hand over the strings. The microprocessor on the electronic guitar of the invention recognizes when a user places his hand over the strings and depresses the strings 14 because all or most of the strings are depressed at once and are not promptly released. When the microprocessor recognizes this pattern, it quickly mutes the guitar and prevents sound from emanating from speakers 41 to 43. When the guitar of the invention is being played in normal fashion, strings are displaced—either individually or together—and then are quickly released. The microprocessor recognizes this as a normal playing pattern and does not mute speakers 41 to 43.

When the guitar of the invention is played, sound initially emanates from speakers 41 to 43. Soon after sound emanates from speakers 41 to 43, the hollow body of the guitar resonates and amplifies a portion of the sound from speakers 41 to 43 such that sound simultaneously emanates both from speakers 41 to 43 and the hollow body. Since the sounds emanating from the speakers 41 to 43 and from the hollow body of the guitar are each produced by or derive from a resonating hollow body, the sound blend well and produce sound equivalent to that produce by a conventional acoustic guitar.

The following terms are utilized herein:

Accent. A greater stress or emphasis given to one musical tone than its neighbors. Accent is often achieved by making one musical tone louder than its neighbors. However, other methods can be utilized to stress a note. Giving a note an unusually short duration in comparison to its neighboring notes can accent the note, as can making a note unusually soft in comparison to its neighbors.

Actual Duration. The time a note actually lasts when a player plays a note or notes. Actual duration may or may not equal the intended duration of a note. For example, a quarter note may be called for in a musical piece played at a particular tempo. The player may play the note as an eighth note, in which case the actual duration does not equal the duration of a quarter note. Or, the player may play the note as a whole note, in which case the actual duration does not equal the duration of a quarter note. Or, the player may play the note as a quarter note, in which case the actual duration equals the duration of a quarter note.

Automatic Operational Mode. In the automatic mode, programming is achieved by a pre-recorded accompaniment track that defines the sequence of chords. The player can not determine the sequence of chords. The accompaniment track defines the sequence of chords and, as a result, the guitar at any given time will only produce notes from a chord defined by the pre-recorded accompaniment track. Each string, when played, produces a particular note in the defined chord. Each note in the defined chord is from a particular musical scale; for example, the C major scale. Each string normally produces a different note in the defined chord. In the automatic mode, the player can not determine the sequence of chords selected. The player can not alter the sequence of selected chords. In order for the guitar to produce a sound during the automatic mode, the player must play a string or strings. The guitar produces the note associated with each string played. If only one string is played, then only that note in the defined chord is produced. If all of the strings are played, then all of the notes in the chord are produced. If the player does not play a string or string, no notes are produced. For example, say that at the beginning of a musical piece the accompaniment track determines that a chord in the C major scale is played for the first two seconds of the piece, that the next chord in the sequence is in the F scale and is played for the third second of the piece, and that the next chord in the sequence is in the G scale and is played for the fourth and fifth seconds of the piece. The piece begins. During the first two seconds the player strums all six strings on the guitar. The guitar produces sounds replicating simultaneously each of the six different notes which are each defined by the accompaniment track and are each in the C major scale. During the third second of the song, the player does not play any string on the guitar. No sound is produced. If the player had played a string, the guitar would have produced a sound replicating a note from the F scale, which note was assigned to the string by the accompaniment track for the third second of the song. During the fourth and fifth seconds of the song, the player strums or picks only two of the six strings on the guitar. The guitar produces sounds replicating the notes assigned to the strings by the accompaniment track for the fourth and fifth seconds of the piece, which notes are from the G scale. In the automatic mode, the guitar normally only produces sounds that correspond to the sequence of chords defined by the accompaniment track, to the duration of each chord defined by the accompaniment track, and to the rests defined by the accompaniment track. The automatic mode is only used when a player is accompanying a pre-recorded musical piece.

Chord. The notes in a selected scale that an electric guitar is programmed to produce when the strings of the guitar are played. When each string is played, the guitar produces a note that is in the selected scale. Chord Programming. Defining chords that an electric guitar produces when the strings of the guitar are played at a particular time. Each chord consists of notes from the same selected scale. Each string, when played, causes the guitar to produce a particular note in the chord.

Duration. The length of time a note is intended to last at a particular tempo. Some notes last a short time. Others last a relatively long time. A whole note has the same time value (i.e., duration) as two half notes or four quarter notes or six eighth notes plus two eighth rests.

Flat. The half tone below a note.

Interval. The distance between two notes in a scale. Intervals are named based on the number of degrees they cover in a major scale. For example, an interval from A to C in the C major scale covers three degrees—A, B, and C—and is called a third. An interval spanning five degrees, such as A to E or C to G, is a fifth.

Letters. In Western music, the letters A to G are used to indicate pitch. Elsewhere, it is Do Re Mi Fa So La Ti.

Manual Operational Mode. In the manual operational mode, programming the chord state which maps the notes of the chord onto the string input members is achieved when a player depresses a button (or activates another chord assignment member) on the neck of the guitar. Each button, when depressed, defines a particular chord that is produced when the strings are played. Each string, when played, produces a particular note in the defined chord. Each note in the defined chord is from a particular musical scale; for example, the C major scale. Each string produces a different note in the chord. In the manual mode, the player determines the sequence of chords selected, the duration of the notes, and rests between notes. The player determines duration, i.e., determines whether the note is a whole note, a quarter note, etc., by how long he holds down a button 31A, 31B or a pedal 72. In order for the guitar to produce a sound during the manual mode, the player must press a button on the neck of the guitar and play a string or strings. The guitar produces the note associated with each string played. If only one string is played, then only that note in the defined chord is produced. If all of the strings are played, then all of the notes in the chord are produced. When the player first begins playing the guitar, if the player does not push a button, no notes are produced. After the player has pushed the first button on the neck of the guitar, the guitar remembers that chord state until a new one is assigned by pressing a new button on the neck of the guitar. If the player does not push a button, no notes are produced. If the player does not play a string or string, no notes are produced. The manual mode can be used to accompany a pre-recorded musical piece. The manual mode can be used when the player is not accompanying a pre-recorded musical piece.

Measure. Also called bar. Is a unit of time in a piece of music. In printed music, measures are separated on the staff by vertical bar lines.

Meter. The way beats are grouped in a measure or piece of music.

One Touch Operational Mode. In the one touch operational mode, programming is determined by a pre-recorded accompaniment track that defines the sequence of chords. The player can not determine the sequence of chords. The accompaniment track defines the sequence of chords and the guitar at any given time will only produce notes from a chord defined by the pre-recorded accompaniment track. Each string, when played, produces a particular note in the chord. Each note in the defined chord is from a particular musical scale; for example, the C major scale. Each string normally produces a different note in the defined chord. In the one-touch mode, the player can not determine the sequence of chords selected. The player can not alter the sequence of selected chords. In order for the guitar to produce a sound during the one-touch mode that corresponds to a chord in the accompaniment track at a particular time during the accompaniment track, the player must, at that particular time in the musical piece, press any button on the neck of the guitar and play a string or strings. The guitar produces the note associated with each string played. If only one string is played, then only that note in the defined chord is produced. If all of the strings are played, then all of the notes in the chord are produced. If the player does not push a button, the guitar continues to play the chord last played. In another embodiment of the one-touch mode, if the player does not push a button, no notes are produced. The guitar can be programmed to either require the player to continue depressing the button while the strings are played, or, to permit the player to release the button while the strings are played. If the player does not play a string or string, no notes are produced. For example, say that at the beginning of a musical piece the accompaniment track determines that a chord in the C major scale is played for the first two seconds of the piece, that the next chord in the sequence is in the F scale and is played for the third second of the piece, and that the next chord in the sequence is in the G scale and is played for the fourth and fifth seconds of the song. The song begins. During the first two seconds the player depresses a button on the neck of the guitar and strums all six strings on the guitar. The guitar produces sounds replicating simultaneously each of the six different notes which are each defined by the accompaniment track and are each in the C major scale. During the third second of the song, the player does not depress a button on the neck of the guitar but does play one or more strings on the guitar. The guitar continues to play notes that were assigned to the C major scale. As noted above, in another embodiment of the one-touch mode, no sound is produced because the player did not both depress a button (any button) on the neck of the guitar and play one or more strings. If the player had depressed a button and played a string, the guitar would have produced a sound replicating a note from the F scale, which note was assigned to the string by the accompaniment program for the third second of the piece. During the fourth and fifth seconds of the piece, the player depresses a button (any button) on the neck of the guitar and strums or picks only two of the six strings on the guitar. The guitar produces sounds replicating the notes assigned to the strings by the accompaniment program for the fourth and fifth seconds of the piece, which notes are from the G scale. In the one touch mode, the guitar only produces sounds that correspond to the sequence of chords defined by the accompaniment track, to the duration of each chord defined by the accompaniment track, and to the rests defined by the accompaniment track. In another “no rest” embodiment of the one-touch mode (or also the automatic mode) there are no rests in the accompaniment track. In the “no rest” embodiment, the player can, if desired, mute the strings by placing his hand on the strings. The programmed duration of each note can be varied as desired, but is presently 4.3 seconds for all operational modes of the guitar. Consequently, during the “no rest” embodiment of the one-touch mode (or also the automatic mode) the player can, practically speaking, produce no sound if he does not strum the strings for 4.3 seconds. If the player strums at least every 4.3 seconds, then the guitar continuously produces sound while accompanying a musical piece. In the “no rest” embodiment, the rests are the times between strumming and the notes can be muted for a rest but the guitar is usually played in a manner wherein the strumming is done in a time and rhythm that carries into the next strumming. In a musical piece there ordinarily are not a lot of opportunities mute the strings and rest. The nature of a guitar causes sound to emanate generally continuously from the guitar. The one touch mode is only used to accompany a pre-recorded musical piece.

Operational Mode. The operational mode determines how the chord programming of an electric guitar is achieved. While any desired operational mode can be selected or programmed into the guitar, the currently preferred operational modes are the manual operation mode, the automatic operational mode, and the one-touch operational mode.

Player Interval. The time between each sequential depressing by a player of a button on the guitar, or, between each instance in which one string is played individually or two or ore strings are played simultaneously. For example, if a player strummed all the strings at essentially the same time, that would be the first instance the player played strings. If the player next “picked” only one string, that would be the second instance the player played strings. The time between the first instance and the second instance is called the player interval.

Rest. A period of silence between notes or chords produced by a guitar. Music on an accompaniment track can, for example, require a rest period of one count between a note played from a C major scale chord and a subsequent note played from a G scale chord. Rests can have different time values. Practically speaking, when one note immediately follows another in a piece of music, there often is a discernible time “interval” between the notes. In other words, a listener can tell when one note stops and when the next note begins even though there is no rest in the music. Such time “intervals” between notes that immediately follow one another are not deemed rests herein. A rest is a period of silence specifically called for in a piece of music or in an accompaniment track.

Rhythm. The way notes are arranged in time. Rhythm includes duration and accent.

Scale. A particular set of tones arranged according to rising or falling pitch.

Sequence. The order in which notes are played.

Sharp. The half tone above a note.

Staff notation. Expresses pitch and rhythm. Signs called notes to represent tones. The shape of a note and the stem, if any, attached to the note define the duration or time value of the note. Notes with a shorter time value than a quarter note have flags. An eighth note has one flag; a sixteenth note, has two flags; and, a thirty-second note has three flags. A dot to the right of a note increases the duration of the note by half. Duration may also be increased by a tie, a curved line that connects consecutive notes of the same pitch. The total duration of tied notes equals that of the notes combined. The position of a note on the staff indicates the pitch of the note.

Time Interval. The time that elapses between the playing of two successive notes, note pairs, or chords in a musical piece. Practically speaking, a short period of time often elapses between the playing of two successive notes or chords even though the music indicates that, for example, an A quarter note is played immediately after a C quarter note. As used herein, however, the time interval between a pair of successive notes or chords is zero unless the music indicates there is a rest between a pair of successive notes or chords.

Time Signature. Indicates meter. Time signature is a fraction that appears at the beginning of a piece of music. The numerator of the fraction tells the number of beats in a measure. The denominator tells what kind of note—half, quarter, or eighth for example—receives one beat.

Tone. Any musical sound of definite pitch. A note.

One embodiment of the invention facilitates the using a guitar to accompany a pre-recorded musical piece. This embodiment of the invention is called the karaoke embodiment, although, as will be evident, a karaoke machine is not required for a player to use the guitar to accompany a pre-recorded piece of music.

In the following discussion, reference is made to a microprocessor. It is understood that the microprocessor and its associated memory may be completely contained 51 in the guitar, may be contained in part in the guitar and in part in one or more locations remote from the guitar (as, for example, in a karaoke machine), or may be contained completely at a location remote from the guitar. When the microprocessor is located at a location remote from the guitar, signals produced when a guitar string 14 is played are transmitted to the microprocessor by infrared signals, radio wave signals, via a hard wire, or by any other desired means. The microprocessor can be located in the guitar and the memory can be located partially outside of the guitar and partially in the guitar. Chord data can be transmitted to the guitar from an external source via infrared signals, radio waves, etc. as can data defining the accompaniment track. The external source can be a television set, or, can be a cartridge that contains data and can be plugged into the guitar to transmit data to the guitar. Similarly, signals produced when a button 31A, 31B is depressed are transmitted to the microprocessor, as well as any other signals produced by activating some other input member on the guitar. For sake, however, of the following discussion, it is assumed that the microprocessor and its associated memory are completely contained 51 in the guitar and that the microprocessor generates the necessary signals to control not only the speakers 41 to 43 mounted in the guitar but to control any other visual displays 80 or audio displays 79.

In FIG. 6, the microprocessor is indicated by reference character 88 and its associated memory is indicated by reference character 89. CRT displays, television screens, and other visual displays controlled by microprocessor 88 are indicated by “visual out” 80. Speakers 41 to 43 and other auxiliary audio outputs controlled by microprocessor 88 are indicated by “audio out” 79. An example of an auxiliary audio output is a karaoke speaker.

Pre-Recording a Selected Musical Piece.

The first step in the karaoke embodiment is to pre-record an audio rendition of a selected musical piece. A musical piece includes instrumental music, includes instrumental music and spoken lyrics, includes instrumental music and a singing rendition of lyrics, or includes only a singing rendition of lyrics. As used herein, lyrics that are spoken with singing and without instrumental music do not comprise a musical piece. A singing rendition means the individual uses his or her vocal chords to produce notes of differing pitch while repeating lyrics and/or intermediate lyrics. A singing rendition can be synthetically produced. The means for pre-recording a musical piece in a digital format—on a CD for example—or in an analog format—on a magnetic tape for example—are well known and are not described herein.

The pre-recording of an audio rendition of a musical piece can also be accomplished simultaneously with a visual or video recording. The video recoding can show an individual or individuals performing the musical piece, can show an animal, can show the countryside, or can produce pictures, drawings, or other depictions (still or moving) of any desired object or objects, events, or other subject matter.

In FIG. 6, the pre-recorded audio rendition, with or without a video recording, is indicated by “prior performance” 87. This optional background video can be switched on or off.

Production of Accompaniment Track.

The next step in the karaoke embodiment is to produce an accompaniment track to accompany the pre-recorded audio rendition. The accompaniment track typically is produced by a studio musician, but can be produced by any individual or apparatus. The purpose of the accompaniment track is chord programming. The accompaniment track defines chords that an electric guitar produces when the strings of the guitar are played at a particular time during the pre-recorded musical piece. Each chord consists of notes from the same selected scale. Each string, when played, causes the guitar to produce a particular note in the chord. The accompaniment track defines the sequence of the musical chords, defines the duration of the musical chords, and defines the time interval between the musical chords. The accompaniment track is synchronized with the pre-recorded audio rendition so that each chord in the accompaniment track can only be played at a particular time during the pre-recorded audio rendition. Apparatus for synchronizing the accompaniment track with the pre-recorded audio rendition is well known, and is not described herein. In FIG. 6, the accompaniment track is indicated by “map of music to accompany performance” 86.

If the pre-recorded musical piece includes lyrics, the chords defined in the accompaniment track can, if desired, be synchronized with the lyrics by lyric definition sub-routine 77 and note/chord definition sub-routine 75 so that when the pre-recorded musical piece is played, a visual display can be produced on a television screen or other visual output 80 that depicts the chord or chords in the accompaniment track that are played with each word in the lyrics or with each syllable in a word in the lyrics. Each word or syllable can be pictured with its associated chord or chords on top of, beneath, in front of, or following the word or syllable. This visual synchronization of the accompaniment track chords with lyrics is believed to facilitate the ability of a guitar player to “stay up” with the lyrics, to replicate the timing of the chords in the accompaniment track, and to synchronize the chords in the accompaniment track with the pre-recorded musical piece in the manner intended by the studio musician that prepared the accompaniment track. Lyric definition sub-routine 77 can also be programmed to produce on the visual output only the lyrics or only the chords.

Data from the accompaniment track is stored in memory 89 as time interval data 81, note/chord data 82, and duration data 83.

Data from the pre-recorded musical piece is stored in memory 89 as performance data 85 and lyric data 84. Performance data 85 includes the lyric data 84, but lyric data 84 is also stored separately to facilitate combining the lyric data with chord data from the accompaniment track.

Selection of Mode of Operation.

A button (not visible) on the underside of neck 30 is used to select the mode of operation of the guitar. A variety of different modes of operation can be programmed into the guitar, as desired. The three presently preferred modes of operation in the karaoke embodiment of the invention are the manual mode, the automatic mode, and the one-touch mode.

The Manual Mode of Operation.

In the manual mode, the accompaniment track is not utilized, and a player is free to play any chords in any sequence, for any duration, and at any time interval. The buttons 31A and 31B on handle 30 in fingerboard 31 are programmed to select the same chord in a particular scale each time a player depresses the button. For example, button 31A produces a chord in the C major scale each time the player presses the button. Button 31B produces a chord in the F major scale each time the player presses the button. The player determines the sequence in which the buttons are pressed, determines how long is button 31A, 31B is depressed, and determines the time that elapses between pushing one button and pushing the next successive button.

The Automatic Mode of Operation.

In the automatic mode, the accompaniment track is utilized and the buttons 31A, 31B on fingerboard 31 are inactivated, or, any signals produced by fingerboard 31 are ignored by microprocessor 88. Microprocessor receives and recognizes signals from strings 14, 71 and, by using data from the accompaniment track, produces an audio output to the speakers 41 to 43 or to any other desired speakers.

In order to initiate the accompaniment with the guitar of a pre-recorded musical piece, an input member (not shown) on the guitar or at some location remote from the guitar is activated to cause performance sub-routine 78 to play the pre-recorded performance on an audio output 79 and/or a video output 80. The microprocessor 88 monitors the accompaniment track while the pre-recorded performance plays.

To produce a sound while accompanying the pre-recorded musical piece during the automatic mode, the player must play a string or strings. When the player plays a string or strings, the note produced by each string corresponds to the note assigned by the accompaniment track. The note is in a chord assigned by the accompaniment track. Each note in the chord is in a musical scale defined by the accompaniment track. Each chord is assigned by the accompaniment track for a particular time period in the pre-recorded musical piece.

The guitar produces in speakers 41 to 43 the note associated with each string played. If only one string is played, then only that note in the defined chord is produced. If all of the strings are played, then all of the notes in the chord are produced. If the player does not play a string or string, no notes are produced.

Example of Automatic Mode of Operation.

For example, say that at the beginning of the pre-recorded musical piece the accompaniment track determines that a chord in the C major scale will be played for the first two seconds of the pre-recorded musical piece, that the second chord in the sequence of chords defined by the accompaniment track is in the F scale and will be played for the third second of the pre-recorded musical piece, and that the third chord in the sequence of chords defined by the accompaniment track is in the G scale and will be played for the fourth and fifth seconds of the pre-recorded musical piece. The initial three chords defined by the accompaniment track are successive chords and there is no rest between any of the chords.

The player hears the pre-recorded musical piece begin.

During the first two seconds of the musical piece, the player strums all six strings on the guitar. The note/chord sub-routine 75 of guitar microprocessor 88 causes speakers 41 to 43 to produce sounds replicating simultaneously each of the six different notes that are each assigned to one of the strings by the accompaniment track and are each in the C major scale. At the conclusion of the first two seconds of the pre-recorded musical piece, the duration sub-routine 76 of microprocessor 88 determines that the two second duration of the six C major scale notes is completed and ceases emanation of sound from speakers 41 to 43. In contrast to the foregoing description of what occurs during the initial two seconds of the musical piece, in another “continuous sound” embodiment of the automatic mode, at the end of the first two seconds of the musical piece, the guitar remembers the C major scale notes and sound continues to emanate from the guitar until either (1) the 4.3 second duration of the notes expires without the player again strumming the strings, or (2) the player strums the strings during the third or later seconds of the musical piece, causing the notes mapped on to the strings for the third or later seconds of the piece to be produced.

During the third second of the pre-recorded musical piece, the player does not play any string on the guitar. No sound is produced. If the player had played a string, (1) the note/chord definition sub-routine 75 would have caused speakers 41 to 43 to produce a sound replicating a note from the F scale, which note was, as earlier noted, assigned to the string by the accompaniment program for the third second of the song, (2) the time interval sub-routine 74 would have determined that the first and second chords were successive chords, and that there was no rest between the chords, and (3) at the conclusion of the third second of the pre-recorded musical piece, the duration sub-routine 78 would have determined that the one-second duration of the F scale notes was completed and would have ceased the emanation of sound from speakers 41 to 43. In contrast to the foregoing description of what occurs during the third second of the musical piece, in the alternate “continuous sound” embodiment noted above, at the conclusion of the one second duration of the F scale notes, the guitar remembers the F-scale notes played by the player and sound continues to emanate from the guitar until either (1) the 4.3 second duration of the notes expires without the player again strumming the strings, or (2) the player strums the strings during the fourth or fifth or later seconds of the musical piece, causing the notes mapped on to the strings for the fourth or fifth or later seconds of the piece to be produced.

During the fourth and fifth seconds of the musical piece, the player strums or picks only two of the six strings on the guitar. The note/chord definition sub-routine 75 causes speakers 41 to 43 to produce sounds replicating simultaneously the different notes that are each assigned to one of the two strings by the accompaniment track and are each in the G major scale. If the two strings are not played simultaneously, but are played one after the other, the sounds from speakers 41 to 43 follow one after the other to replicate the sequential playing of the strings. The time interval sub-routine 74 determines that the second and third chords are successive chords and that there is no rest between the chords. At the conclusion of the fourth and fifth seconds of the pre-recorded musical piece (and the accompaniment track), the duration sub-routine 76 of microprocessor 88 determines that the two second duration of the two G major notes is completed and ceases emanation of sound from speakers 41 to 43.

In contrast to the foregoing description of what occurs during the fourth and fifth seconds of the musical piece, in the alternate “continuous sound” embodiment noted above, at the conclusion of the two-second duration of the G major scale notes, the guitar remembers the G scale notes played by the player and sound continues to emanate from the guitar until either (1) the 4.3 second duration of the notes expires without the player again strumming the strings, or (2) the player strums the strings during the sixth or later seconds of the musical piece, causing the notes mapped on to the strings for the sixth or later seconds of the piece to be produced.

If desired, microprocessor 88 can be programmed such that during the automatic mode, a note or notes in a chord in the accompaniment track will continue to be played as long as the player depresses a button 31A, 31B on fingerboard 70 or depresses a pedal 72 operatively associated with the guitar. Once the button is released, if the duration as defined by duration sub-routine 76 had earlier expired, then duration sub-routine 76 ceases emanation of sound from speaker 41 to 43. (In another embodiment, once the button is released, if the duration as defined by duration sub-routine 76 had NOT earlier expired, then duration sub-routine 76 still ceases emanation of sound from speaker 41 to 43.) The player must then again play at least one of strings 14 to produce a sound from speakers 41 to 43. If the player plays a string at a time during the pre-recorded musical piece when the accompaniment track assigns a chord to the strings, then a sound is produced by speakers 41 to 43 that corresponds to the notes assigned to the strings played. If, however, the player plays a string at a time during the pre-recorded musical piece when the accompaniment track assigns a rest, then sound is not produced by speakers 41 to 43. As noted above, in another “no rest” embodiment of the automatic mode there are no rests in the accompaniment track. In the “no rest” embodiment, the player can, if desired, mute the strings by placing his hand on the strings. The programmed duration of each note can be varied as desired, but is presently 4.3 seconds for all operational modes of the guitar. Consequently, during the “no rest” embodiment of the automatic mode the player can, practically speaking, produce no sound if he does not strum the strings for 4.3 seconds. If the player strums at least every 4.3 seconds, then the guitar continuously produces sound while accompanying a musical piece.

One-Touch Mode of Operation.

In the one-touch mode, the accompaniment track is utilized and the microprocessor 88 receives signals from at least one button 31A, 31B on fingerboard 31. The microprocessor does not utilize the signal from a button 31A, 31B to assign a chord to strings 14, 71. The chord assigned to strings 14 is determined by the accompaniment track.

In the automatic mode described above, the player must play one or more strings to cause speakers 41 to 43 to produce sound. In contrast, in the one-touch mode, the player must, in order to play the chord assigned by the accompaniment track at a particular point or time in the accompaniment track, both press a button on the fingerboard 31, 70 and play one or more strings at that particular point in the accompaniment track to cause speakers 41 to produce the chord assigned by the accompaniment track. Microprocessor receives and recognizes signals from strings 14 and fingerboard 31, 70 and, by using data from the accompaniment track, produces an audio output to the speakers 41 to 43 or to any other desired speakers.

During the one-touch mode, an input member (not shown) on the guitar or at some location remote from the guitar is activated to cause performance sub-routine 78 to play the pre-recorded performance on an audio output 79 and/or a video output 80. The microprocessor 88 monitors the accompaniment track while the pre-recorded performance plays.

In order for the guitar to produce a sound during the one-touch mode, the player must, at the correct time in a musical piece, depress a button on fingerboard 31, 70 and play a string or strings. When the player depresses a button 31A, 31B and plays a string or strings, the note produced by speakers 41 to 43 for each string played corresponds to the note assigned by the accompaniment track. The note is in the chord assigned by the accompaniment track at that particular time in the pre-recorded musical piece. Each note in the assigned chord is in the same musical scale.

The guitar produces the note associated with each string played. If only one string is played, then only that note in the defined chord is produced. If all of the strings are played, then all of the notes in the chord are produced. If the player does not depress a button 31A, 31B and play a string or strings 14, no notes are produced by speakers 41 to 43.

Example of One-Touch Mode of Operation.

For example, say that at the beginning of the pre-recorded musical piece the accompaniment track determines that a chord in the C major scale will be played for the first two seconds of the pre-recorded musical piece, that the second chord in the sequence defined by the accompaniment track is in the F scale and will be played for the third second of the pre-recorded musical piece, and that the third chord in the sequence defined by the accompaniment track is in the G scale and will be played for the fourth and fifth seconds of the pre-recorded musical piece. The initial three chords are successive chords and there is no rest between any of the chords.

The player hears the pre-recorded musical piece begin.

During the first two seconds of the musical piece, the player presses a button 31A, 31B and strums all six strings on the guitar. The note/chord sub-routine 75 of guitar microprocessor 88 causes speakers 41 to 43 to produce sounds replicating substantially simultaneously each of the six different notes that are each assigned to one of the strings by the accompaniment track and are each in the C major scale. At the conclusion of the first two seconds of the pre-recorded musical piece, the duration sub-routine 76 of microprocessor 88 determines that the two second duration of the six C major scale notes is completed and ceases emanation of sound from speakers 41 to 43. In contrast to the foregoing description of what occurs during the initial two seconds of the musical piece, in another “continuous sound” embodiment of the one-touch mode, at the end of the first two seconds of the musical piece, the guitar remembers the C major scale notes and sound continues to emanate from the guitar until either (1) the 4.3 second duration of the notes expires without the player again strumming the strings, or (2) the player strums the strings during the third or later seconds of the musical piece, causing the notes mapped on to the strings for the third or later second of the piece to be produced.

During the third second of the pre-recorded musical piece, the player strums the strings on the guitar but fails to depress a button 31A, 31B. No sound is produced. In contrast to the foregoing description of what occurs during the third second of the musical piece, in the alternate “continuous sound” embodiment of the one touch mode noted above, at the conclusion of the two-second duration of the C scale notes, the guitar remembers the C-scale notes previously played by the player and sound continues to emanate from the guitar until either (1) the 4.3 second duration of the notes expires without the player again strumming the strings, or (2) the player depresses a button (any button) on the neck of the guitar and strums the guitar strings. When the player depresses a button on the neck, the microprocessor maps the correct current chord state onto the input members (strings). If the player presses a button on the neck and strums while the guitar is still producing sound corresponding to the C scale notes, the C scale note sound is terminated and sound is produced that corresponds to the newly mapped chord. If the player had depressed a button 31A, 31B before or simultaneously with strumming the strings, (1) the note/chord definition sub-routine 75 would have caused speakers 41 to 43 to produce a sound replicating notes from the F scale, which notes were, as earlier noted, assigned to the strings by the accompaniment program for the third second of the song, (2) the time interval sub-routine 74 would have determined that the first and second chords were successive chords, and that there was no rest between the chords, and (3) at the conclusion of the third second of the pre-recorded musical piece, the duration sub-routine 78 would have determined that the one-second duration of the F scale notes was completed and would have ceased the emanation of sound from speakers 41 to 43. In contrast to the foregoing description of what occurs during the third second when the player depresses a button on the guitar neck and strums the strings, in the alternate “continuous sound” embodiment of the one-touch mode earlier discussed, at the conclusion of the one-second duration of the F scale notes, the guitar remembers the F-scale notes played by the player and sound continues to emanate from the guitar until either (1) the 4.3 second duration of the notes expires without the player again strumming the strings, or (2) the player depresses a button on the guitar neck and strums the strings during the fourth or fifth or later seconds of the musical piece, causing the notes mapped on to the strings for the fourth or fifth or later seconds of the piece to be produced.

During the fourth and fifth seconds of the pre-recorded musical piece, the player depresses a button 31A, 31B and strums or picks only two of the six strings on the guitar. The note/chord definition sub-routine 75 causes speakers 41 to 43 to produce sounds replicating simultaneously the different notes that are each assigned to one of the two strings by the accompaniment track and are each in the G major scale. If the two strings are not played simultaneously, but are played one after the other, the sounds from speakers 41 to 43 follow one after the other to replicate the sequential playing of the strings. The time interval sub-routine 74 determines that the second and third chords are successive chords and that there is no rest between the chords. At the conclusion of the fourth and fifth seconds of the pre-recorded musical piece (and of the accompaniment track), the duration sub-routine 76 of microprocessor 88 determines that the two second duration of the two G major notes is completed and ceases emanation of sound from speakers 41 to 43. In contrast to the foregoing description of what occurs during the fourth and fifth seconds of the musical piece, in the alternate “continuous sound” embodiment of the one-touch mode discussed above, at the conclusion of the two-second duration of the G major scale notes, the guitar remembers the G-scale notes played by the player and sound continues to emanate from the guitar until either (1) the 4.3 second duration of the notes expires without the player again strumming the strings, or (2) the player depresses one of the buttons on the guitar neck and strums the strings during the sixth or later seconds of the musical piece, causing the notes mapped on to the strings for the sixth or later seconds of the piece to be produced.

One-Touch Mode of Operation: Chord Change Only When New Button Depressed

In another embodiment of the one-touch mode, the microprocessor 88 is programmed such that after a button 31A, 31B is depressed, (1) the note/chord definition sub-routine 75 causes—when the string(s) are played—speakers 41 to 43 to produce a sound replicating notes in the particular chord assigned to the strings by the accompaniment program at that particular point in time in the accompaniment program (and in the pre-recorded musical piece), and (2) the note-chord definition sub-routine 75 causes that particular chord to continue to be assigned to the strings until the player once again depresses a button 31A, 31B. Consequently, if for the remainder of the accompaniment routine the player does not depress a button 31A, 31A, said particular chord remains assigned to the strings and the strings, when played, will only replicate notes in that particular chord.

For example, say that at the beginning of the pre-recorded musical piece the accompaniment track determines that a chord in the C major scale will be played for the first two seconds of the pre-recorded musical piece, that the second chord in the sequence defined by the accompaniment track is in the F scale and will be played for the third second of the pre-recorded musical piece, and that the third chord in the sequence defined by the accompaniment track is in the G scale and will be played for the fourth and fifth seconds of the pre-recorded musical piece. The initial three chords are successive chords and there is no rest between any of the chords.

The player hears the pre-recorded musical piece begin.

During the first two seconds of the musical piece, the player presses a button 31A, 31B and strums one or more strings on the guitar. When each string is played, the note/chord sub-routine 75 of guitar microprocessor 88 causes speakers 41 to 43 to produce sounds replicating the note in the C major scale that is assigned to each one of the strings by the accompaniment track.

During the third second of the pre-recorded musical piece, the player strums the strings on the guitar but fails to depress a button 31A, 31B. Since the player did not depress a button 31A or 31B, the microprocessor continues to assign to the strings the notes in the C major scale chord that were assigned to the strings during the initial two seconds of the pre-recorded musical piece. When the player plays one or more strings during the third second, the note/chord sub-route 75 of microprocessor 88 causes speakers 41 to 43 to produce sounds that continue to replicate notes in the C major scale chord. If, during the third second of the pre-recorded musical piece, the player had depressed a button 31A, 31B before or simultaneously with strumming the strings, the note/chord definition sub-routine 75 would have assigned to the strings notes from the F scale chord in the accompaniment program and would have, when each string or strings were played, caused speakers 41 to 43 to produce a sound replicating a note or notes from the F scale.

During the fourth second of the pre-recorded musical piece, the player depresses a button 31A, 31B and strums or picks simultaneously only two of the six strings on the guitar. As soon as the player depresses a button 31A, 31B, the note/chord definition sub-routine 75 causes speakers 41 to 43 to produce sounds replicating simultaneously the different notes that are each assigned to one of the two strings by the accompaniment track and that are each in the G major scale. If the two strings are not played simultaneously, but are played one after the other, the sounds from speakers 41 to 43 follow one after the other to replicate the sequential playing of the strings.

During the fifth second of the pre-recorded musical piece, the player does not depress a button 31A, 31B but continues to play strings on the guitar. Since the player does not depress a button 31A, 31B, the microprocessor 88 continues to assign to the strings the notes in the G major scale chord that were assigned to the strings during the fourth second of the pre-recorded musical piece. If the player had depressed a button 31A, 31B during the fifth second of the pre-recorded musical piece, the note/chord definition sub-routine 75 would have determined from the accompaniment track that during the fifth second of the musical piece notes in the G major scale chord are still assigned to the strings and that, as a result, the notes assigned to the strings during the fourth second of the musical piece continue to be assigned to the strings during the fifth second of the musical piece—regardless of whether the player presses a button 31A, 31B.

Signal Generated Once Button Depressed.

In the foregoing descriptions of the manual mode and the one-touch mode, as soon as a button 31A, 31B is depressed, the microprocessor receives a signal from the button and assigns chord notes to the strings. Continuing to hold the button 31A, 31B down does not alter the signal from the button to the microprocessor 88. Another signal from a button 31A, 31B is not generated until the button is released and depressed, or, until another button is depressed.

One-Touch Mode of Operation: Microprocessor Configured to Extend Duration When Button is Held Down.

If desired, microprocessor 88 can be programmed such that during the one-touch mode, a note or notes in a chord in the accompaniment track will continue to be played as long as the player continues to depress a button 31A, 31B on fingerboard 70 or continues to depress a pedal 72 operatively associated with the guitar. Once the button is released, if the duration as defined by duration sub-routine 76 had earlier expired, then duration sub-routine 76 ceases emanation of sound from speakers 41 to 43. The player must then again depress a button 31A, 31B and play at least one of strings 14 to produce a sound from speakers 41 to 43. If the player depresses a button and plays a string at a time during the pre-recorded musical piece when the accompaniment track assigns a chord to the strings (and therefore assigns a note to each string that is produced by speakers 41 to 43 when a string is played), then a sound is produced by speakers 41 to 43 that corresponds to the notes assigned to the strings played. If, however, the player depresses a button and plays one or more string(s) at a time during the pre-recorded musical piece when the accompaniment track assigns a rest, then sound is not produced by speakers 41 to 43. As noted above, in another “no rest” embodiment of the one-touch mode there are no rests in the accompaniment track. In the “no rest” embodiment, the player can, if desired, mute the strings by placing his hand on the strings. The programmed duration of each note can be varied as desired, but is presently 4.3 seconds for all operational modes of the guitar. Consequently, during the “no rest” embodiment of the one-touch mode the player can, practically speaking, produce no sound if he does not strum the strings for 4.3 seconds. If the player strums at least every 4.3 second, then the guitar continuously produces sound while accompanying a musical piece.

Control of Sequence, Duration and Time Intervals by Accompaniment Track.

One believed virtue of the automatic and one-touch modes is that it facilitates a player's practicing playing the guitar strings or strings/buttons at the correct times while accompanying a pre-recorded musical piece. The automatic and one-touch modes facilitate such practicing because these modes generally do not permit a player to determine the sequence of chords, duration of chords, or time interval between chords when the chords are produced on speakers 41 to 43. The accompaniment track determines the sequence of chords, duration of chords, and time intervals between chords that are played on speakers 41 to 43. Even if, as noted, the microprocessor 88 is programmed to permit a player to continue playing strings to produce notes in a chord as long as (1) a button 31A, 31B or pedal 72 is depressed or (2) a new button is not depressed (in the one-touch mode), the player can not alter the sequence of chords defined in the accompaniment track. This simplifies playing the guitar of the invention and is believed to facilitate a player's learning when to play strings and depress buttons while accompanying a pre-recorded musical piece. The objective of the automatic and one-touch modes is to have a player perform (1) the specific sequence of chords set forth in the accompaniment track, (2) at the specific times during the pre-recorded musical piece as defined by the accompaniment track, (3) and at the time intervals defined by the accompaniment track.

A further objective of the automatic and one-touch modes is to remove functional elements of the guitar and thereby reduce the player's burden of responsibility for creating all aspects of making music. The player can then concentrate on rhythm and fundamental elements of rhythm in the automatic mode without also concentrating on changing chords and forming chords. These modes provide for a means by which a player may adjust the functionality of the guitar to match the player's skill level and create a successful music making experience. Additionally, these modes of operation provide for the player a means by which to isolate aspects of making music until sufficient skill is achieved to add further aspects until such time as the player is capable of operating the instrument independent of any programmed assistance. It is believed that this process of function isolation will be very valuable in the process of learning to play any instrument since the variables and functions are common to all instruments. The guitar of this invention is the first instrument that provides the opportunity to break down the process of making music into simple and isolated components. It is also the only instrument that is functionally adjustable to match the skill level of the player. The instrument of this invention will be the ideal instrument for all new musicians to learn these fundamental elements and to practice making music one step at a time. In a similar fashion to learning how to drive a car with an automatic transmission, it is easier to learn the aspect of steering, acceleration, and braking without the added burden of clutch and shifting gears. These aspects can be added and learned after the first elements are mastered.

Rhythm is the temporal pattern produced by the grouping and balancing of varying stresses and tone lengths in relation to an underlying steady and persisting succession of beats: the aspect of music comprising all the elements (as accent, meter, time, tempo) that relate to forward movement as contrasted with pitch sequence or tone combination. A symmetrical and regularly recurrent grouping of tones according to accent and time values, for example, the rumba.

Meter is the part of rhythmical structure concerned with the division of a musical composition into measures by means of regularly recurring accents with each measure consisting of a uniform number of beats or time units the first of which has the strongest accent. The distribution of long and short notes or tones with measures.

Tempo is the rate of rhythmic recurrence or movement; specifically, the rate of speed of a musical piece or passage indicated by one of a series of directions associated conventionally with speed (as largo, presto, allegro) and often by an exact metronome marking.

Time is the grouping of the successive rhythmic beats or pulses as represented by a musical note taken as a time unit unto measures or bars that are marked off by bar lines according to the position of the principal accent. Time is also the tempo at which music is performed.

Combination of Chords and Lyrics in Visual Display.

Another feature of the invention believed to facilitate learning to play a guitar is the ability to produce a visual display that, while a pre-recorded musical piece is played, simultaneously and synchronously shows the lyrics of the piece along with the chords to be played to accompany the lyrics. Chords can be played with or without each word or syllable in the lyrics, i.e., in some cases chords may be played between, and not with, lyrics. A visual display of such “in between” chords can also be provided in the practice of the invention along with the display of chord—word pairs illustrating the chord or chords played simultaneously with each word in the lyrics.

Methods of Providing Accompaniment Track.

The accompaniment track 86 can be provided from any desired source including, by way of example, a data cartridge that can be plugged into a port in the guitar.

Another method for providing an accompaniment track is to download the track from a computer network. Another method is to upgrade the internal memory or connect to an external memory.

A further method for providing an accompaniment track is to download the accompaniment track from a television set. In particular, while a pre-recorded musical piece is being performed on the television set, the appropriate accompaniment track can be simultaneously transmitted and downloaded into memory 88 via a connection between the television set and the guitar. The connection can be a hard wire, via an infrared transmission from the television set to the guitar, etc. The accompaniment track can also be transmitted prior to the performance on the television set of the pre-recorded musical piece. Such a transmission of the accompaniment track (before or concurrently with the performance of the pre-recorded musical piece) over the television set would permit a player to attempt to accompany the performance on the television set of pre-recorded musical piece.

A further method of providing an educational and entertaining interactive activity is through the use of computer game consoles which would require the creation of a computer game cartridge which would be compatible with pre-existing computer game consoles like those already found in the marketplace. The games would provide for multiple modes of practice and performance and scoring for competition with self or others. The games would also provide multiple modes of interaction which would test the various skill levels of the player and provide various methods of operation that would make it possible to score and compete with others. The games would also provide multiple modes of interaction and challenge in increasingly more difficult modes of operation such that graduation to increasingly more difficult levels of operation become the object of the interaction. The games would provide for multiple modes of interaction which would allow the player to replicate the performance of famous artists in a performance environment and the player would have control options including view angles and camera angles and the capacity to interact with other “performers” either real or virtual.

A further method of interaction would be through the instrument's ability to connect to the Internet and be used to create music and interact with others also possessed of the instrument or other instruments through an interactive website wherein players could interact and create music from remote locations throughout the world.

A further method of interaction would be provided through the Internet's capacity to host a recording studio environment wherein the player can record himself in the same manner that professional studios operate. A home version of this recording studio program can be made available to the player without requiring the player to interact with the Internet.

Existing song lyrics can be packaged to produce a visual image showing the lyrics along with the chord(s) (showing the notes in the chord) or a notation of the chord(s) (i.e., the notation “C” for the C chord) played by a guitar with each lyric and/or along with a depiction of another musical note(s) played by the guitar with each lyric. The chords, chord notation, or other notes can be shown at any desired location or locations in the lyrics. It is possible, for example, to simply show a single chord for an entire song, which chord might indicate the beginning chord in the song. Or, two or more chords or chord notations or other notes can be included to be viewed concurrently with the lyrics. Such packaged lyrics can also include an accompaniment track for downloading to a guitar constructed in the manner described above so that the guitar can use the automatic mode, the one-touch mode, or some other programmed mode to accompany the lyrics.

Having described my invention in such terms as to enable those of skill in the art to make and practice it, and having described the presently preferred embodiments thereof, I claim:

1. A system for accompanying a recording of a prior musical performance including lyrics and music, the system including
(a) memory apparatus to store
(i) the recording of the prior musical performance, including the lyrics and the music,
(ii) an accompaniment of the prior musical performance, said accompaniment including chord data, duration data, and time interval data,
(b) apparatus operatively associated with said memory apparatus for
(i) playing the recording,
(ii) synchronizing said accompaniment with said playing of the recording,
(iii) synchronizing said chord data with the lyrics,
(iv) producing during said playing of the recording a visual display of said synchronized chord data and lyrics; and,
(v) playing said accompaniment during said playing of the recording.

2. A system for accompanying a recording of a prior musical performance including lyrics and music, the system including
(a) memory apparatus to store
(i) the recording of the prior musical performance, including the lyrics and the music,
(ii) an accompaniment of the prior musical performance, said accompaniment including chord data, duration data, and time interval data;
(b) apparatus operatively associated with said memory apparatus for playing the recording;
(c) an electric guitar system including input members actuated by a player at time intervals to produce chords defined by said chord data and said duration data in a sequence defined by said accompaniment.

3. A system for accompanying a recording of a prior musical performance including lyrics and music, the system including
(a) memory apparatus to store
(i) the recording of the prior musical performance, including the lyrics and the music,
(ii) an accompaniment of the prior musical performance, said accompaniment including chord data, duration data, and time interval data;
(b) apparatus operatively associated with said memory apparatus for playing the recording;
(c) an electric guitar system including
(i) first input members actuated by a player at time intervals to select chords defined by said chord data in a sequence defined by said accompaniment, and
(ii) second input members actuated by a player at time intervals defined by said time interval data to play said chords selected by said first input members.
to replicate said accompaniment.

4. A guitar for selectively practicing different rhythmic elements to facilitate learning techniques necessary to play the guitar, the guitar including
(a) a microprocessor;
(b) strings, each of said strings when strummed producing a signal that is received by the microprocessor such that the microprocessor causes a sound to be produced;
(c) buttons, each button when activated producing a signal that is received by the microprocessor such that the microprocessor causes a sound to be produced;
(d) a first mode of operation during which sounds are produced only by strumming at least one of said strings; and,
(e) a second mode of operation during which sounds are produced by strumming at least one of said strings and activating at least one of said buttons.
